(19) United States
(12) Patent Application Publication
(10) Pub. No.: US 2008/0275778 A1
(43) Pub. Date: Nov. 6, 2008

(54) Method of Community Service and Disaster Relief

(76) Inventor: James H. Johnson, Lexington, KY (US)

Correspondence Address: KING & SCHICKLI, PLLC, 247 NORTH BROADWAY, LEXINGTON, KY, 40507, US

(21) Appl. No.: 11/996,693

(22) PCT Filed: Jul. 25, 2006
(86) PCT No.: PCT/US06/28867

§ 371 Date: Jan. 24, 2008

Related U.S. Application Data
(60) Provisional application No. 60/702,476, filed on Jul. 26, 2005.
(60) Provisional application No. 60/727,136, filed on Oct. 14, 2005.
(60) Provisional application No. 60/781,800, filed on Mar. 13, 2006.
(60) Provisional application No. 60/781,801, filed on Mar. 13, 2006.

(51) Int. Cl. G09F 9/37; G06Q 30/00

(52) U.S. Cl. 705/14; 705/500

(57) ABSTRACT

The present invention relates to a method of community service including the steps of providing a site placement for a storage structure and allowing a relief organization to stage disaster relief supplies in that storage structure in anticipation of a possible disaster.

This application claims the benefit of U.S. provisional application Ser. Nos. 60/702,476 filed on 26 Jul. 2005, 60/727,136 filed on 14 Oct. 2005, 60/781,800 filed on 13 Mar. 2006 and 60/781,801 filed 13 Mar. 2006.

### TECHNICAL FIELD

The present invention relates to the fields of public service and disaster relief.

### BACKGROUND OF THE INVENTION

Recent events including, particularly, the catastrophic destruction of New Orleans by Hurricane Katrina have highlighted a need for the establishment of emergency relief provision storage facilities in and around “at risk” population centers. Significantly, roads may be partially blocked or impassable following a disaster. Not only does this greatly limit or prevent people in need from reaching emergency supplies, it also greatly limits or prevents a relief agency from efficiently delivering emergency supplies to the people. As a consequence, it is clear that relief supplies need to be in place at the local level in anticipation of a disaster event: that is, before the disaster occurs. Only then is it possible to immediately distribute supplies into the hands of people in need in the immediate aftermath of a disaster.

### SUMMARY OF THE INVENTION

In accordance with the present invention, a method of public service is provided. That method comprises the step of providing a site placement for a structure holding disaster relief supplies in anticipation of a possible disaster. Stated another way the method comprises the steps of establishing a retail business with multiple sites and providing site placements at the multiple retail sites for structures holding disaster relief supplies in anticipation of a possible disaster. Still further, the method may be described as comprising the steps of providing a site placement for a storage structure and allowing a relief organization to stage disaster relief supplies in the storage structure in anticipation of a possible disaster. The method may also include the step of presenting or marketing advertising on the storage structure for the relief supplies. In addition, the method may include sharing revenue generated from the sale of advertising with an emergency relief organization.

The following is a detailed description of the invention. It should be realized, however, that this is just one possible embodiment of the invention and its several details are capable of modification in various, obvious aspects all without departing from the invention. Accordingly, the drawings and descriptions will be regarded as illustrative in nature and not as restrictive.

### BRIEF DESCRIPTION OF THE DRAWING

The accompanying drawing incorporated in and forming a part of this specification, illustrates several aspects of the present invention and together with the description serves to explain certain principles of the invention. In the drawing:

FIG. 1 is a perspective view of an emergency relief supply staging and/or storage structure; and

FIG. 2 is a schematical end elevational view of the structure of FIG. 1 through the open end doors.

### DETAILED DESCRIPTION OF THE INVENTION

In accordance with the present invention, a method of public or community service is provided. That method may be broadly defined as including the steps of providing a site placement for a structure holding disaster relief supplies in anticipation of a possible disaster.

The method may also include the placing of a storage structure at the site, the stocking of the storage structure with emergency relief supplies and/or the marketing or presenting of advertising on the storage structure. In addition, revenue generated from the marketing or sale of advertising may be shared with any disaster relief organization. Stated another way, the method may include the steps of establishing a retail business with multiple sites and providing site placements at those multiple retail sites for structures holding disaster relief supplies in anticipation of a possible disaster. Still further, the method may be described as including the steps of providing a site placement for a storage structure and allowing a relief organization to stage disaster relief supplies in that storage structure in anticipation of a possible disaster. This may include storing the disaster relief supplies in the structure for long periods of time or leaving the storage structure empty and only moving relief supplies into the structure when, for example a disaster, such as a hurricane, is predicted to strike an area. By providing structures filled with disaster relief supplies at various locations prior to an actual disaster, the supplies are in place for direct distribution to those in need immediately following any disaster event. In other words, the supplies do not need to be transported anywhere. The supplies are already in place at strategic locations for actual distribution to the public.

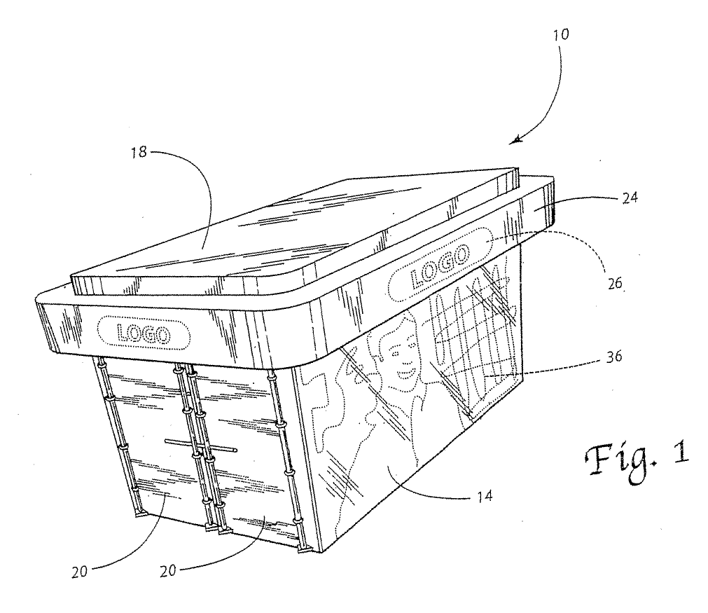

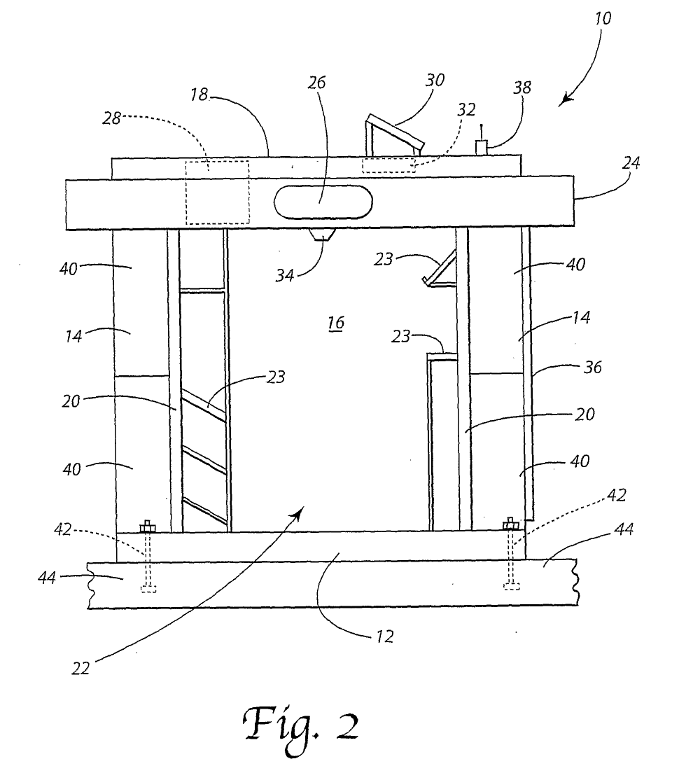

One possible construction of an emergency relief supply staging and/or storage structure 10 is illustrated in FIGS. 1-2. More specifically, the structure 10 includes a floor 12, two side walls 14, an end wall 16 and a roof 18. A pair of cooperating, locking doors 20 define a second end wall opposite the first end wall 16. Any type of door 20 useful for the intended purpose may be utilized. Together, the floor 12, side walls 14, end walls 16, roof 18 and doors 20 define an interior space 22. That space 22 may be customized to meet any special needs for storing or staging emergency relief supplies such as water, food, baby formula, diapers, medicine, first aid kits, blankets, tents, bedding, communications equipment such as walkie talkies and satellite telephones and the like.

Similarly, the exterior of the structure 10 may be customized to match the trade dress of substantially any desired party and/or architectural features of any building near which the structure 10 may be placed into service. Thus, for example, the structure 10 may include a decorative roof cap 24 sized and shaped to a user's specifications. The roof cap 24 may include advertising, trade dress or logo 26 if desired and/or as allowed by local regulations.

The structure 10 may also be equipped with various electrical and/or mechanical systems. For example, a climate control unit 28 such as an air conditioner, refrigerator or freezer may be provided on the structure 10 in order to provide climate control of a portion or all of the space 22 within the storage structure. For example, a portion of a structure 10 may be cooled with air conditioning in order to extend the shelf life of bottled water stored in the structure. Another portion of the structure may be equipped with a freezer unit to store ice.

In addition, the structure 10 may be equipped with a solar panel 30 and cooperating battery 32 to store energy for powering an internal lighting system 34 for illuminating the space 22. Still further, the structure may include an emergency power source such as an electric generator 31 run by an internal combustion engine, natural gas, propane, a fuel cell or other energy source. Such a power source could not only be used to power the climate control unit 28, but also a radio transmitter, a speaker system or the like provided on the structure to broadcast an emergency message. Such a message could include, for example, directions to the nearest tent city or emergency relief resupply station.

The structure 10 may be constructed, for example, from modular building materials such as prefabricated panels 40 of the type shown and described in, for example, U.S. Pat. Nos. 6,279,287 to Meadows, 5,373,678 to Hesser and 6,119,427 to Wyman et al. Such modular panels 40 typically incorporate a core of thermal insulating material sandwiched between metal or plastic sheathing. Such a construction provides both efficient and effective control of the temperature and humidity of the environment in the internal space 22 and excellent inclement weather durability for a long, low-maintenance service life. Structures 10 constructed from such modular building panels 40 are also characterized by high strength and will resist high winds and maintain a weather-tight enclosure to protect products held in the space 22 from inclement weather. In fact, such structures may be easily anchored to the ground such as by means of cooperating nut and bolt anchors 42 where the bolt is received and held in an underlying poured concrete pad 44. Such structures may be specifically designed to withstand winds associated with Category 3, Category 4 or even Category 5 hurricanes as desired. The modular panels 40 also allow the structure 10 to be quickly and easily erected and subsequently removed in a minimal amount of time while producing a minimum of mess.

It should also be appreciated that the structure 10 may be equipped with an advertising medium 36 on, for example, a sidewall 14 thereof. That advertising medium may take substantially any form including but not limited to a banner, a rotary sign assembly of the type described in U.S. Pat. No. 4,021,946, an electronic message board, a plasma monitor, an LED display or a liquid crystal display. By marketing advertising on the side of the structure 10 it is possible to offset the cost of providing the structure for holding the emergency relief supplies.

The foregoing description of a preferred embodiment of the present invention has been presented for purposes of illustration and description. It is not intended to be exhaustive or to limit the invention to the precise form disclosed. Obvious modifications or variations are possible in light of the above teachings. For example, the door 20 may be provided in the side wall 16 rather than the end wall. Further, more than one set of doors 20 may be provided if desired. The structure could also include a tap connected to the public water supply. Still further, the structure could include a toilet and a shower connected to the public water supply and waste lines. In addition the structure could include additional communications equipment such as one or more satellite phones.

The embodiment was chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally and equitably entitled. The drawings and preferred embodiments do not and are not intended to limit the ordinary meaning of the claims and their fair and broad interpretation in any way.

What is claimed:

1. A method of community service, comprising:
providing a site placement for a structure holding disaster relief supplies in anticipation of a possible disaster.

2. The method of claim 1, including placing a storage structure at said site.

3. The method of claim 2, including stocking said storage structure with emergency relief supplies.

4. The method of claim 2, including marketing advertising on said storage structure.

5. The method of claim 4, including sharing revenue generated by said marketing of advertising with a disaster relief organization.

6. A method of community service, comprising:
establishing a retail business with multiple sites;
providing site placements at said multiple retail sites for structures holding disaster relief supplies in anticipation of a possible disaster.

7. The method of claim 6, including placing a storage structure at said site.

8. The method of claim 7, including stocking said storage structure with emergency relief supplies.

9. The method of claim 7, including marketing advertising on said storage structure.

10. A method of community service, comprising:
providing a site placement for a storage structure;
allowing a relief organization to stage disaster relief supplies in said storage structure in anticipation of a possible disaster.

11. The method of claim 10, including placing a storage structure at said site.

12. The method of claim 11, including stocking said storage structure with emergency relief supplies.

13. The method of claim 11, including marketing advertising on said storage structure.

14. A method of community service, comprising:
providing a site placement for a storage structure holding disaster relief supplies in anticipation of a possible disaster; and
presenting advertising on said storage structure.
